(19) United States
(12) Patent Application Publication
(10) Pub. No.: US 2026/0080149 A1
(43) Pub. Date: Mar. 19, 2026

(54) Data Pagination Automation Method and Related Computer System

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Chuo-Jui Wu, Taipei (TW)

(73) Assignees: Inventec (Pudong) Technology Corp., Shanghai (CN); Inventec Corporation, Taipei (TW)

(21) Appl. No.: 19/234,296

(22) Filed: Jun. 11, 2025

(30) Foreign Application Priority Data
Sep. 19, 2024 (CN) 202411310880.2

(51) Int. Cl. G06F 40/114; G06F 7/08; G06F 16/22; G06F 40/177; H04L 9/06

(52) U.S. Cl. CPC G06F 40/114; G06F 7/08; G06F 16/2282; G06F 40/177; H04L 9/0643

(57) ABSTRACT

A data pagination automation method, for processing a plurality of data items includes determining a sorting basis for sorting the plurality of data items according to an ordered unique key of the plurality of data items; sorting and paginating the plurality of data items according to the sorting basis; and updating a pagination information table of the plurality of data items and collecting corresponding data according to the ordered unique key and at least a filtering condition; wherein the pagination information table is updated with to a partial dynamic update method.

### BACKGROUND OF THE INVENTION

### 1. Field of the Invention

The present invention relates to a data pagination automation method and a related computer system, and more particularly, to a data pagination automation method and a related computer system capable of automatically paginating massive data.

### 2. Description of the Prior Art

With the importance of information safety, the application programming interface (API) of the conventional database provides the user to download data to reduce the risk of data leakage. However, the conventional application program interface performs the filtering after downloading the complete data. When downloading excessive data, the burden of the database and the transmission time is increased.

In order to solve the problem of massive data, pagination is utilized by the conventional application program interface, e.g. offset-based pagination, time-based pagination and cursor-based pagination. However, additional sorting logic is required for the offset-based pagination and the cursor-based pagination, which exponentially increases the quantity of the data sheet. The time-based pagination is easily affected by the volume of the data.

Therefore, improvements are necessary to the conventional techniques.

### SUMMARY OF THE INVENTION

Therefore, the present invention provides a data pagination automation method and a related computer system to automatically paginate the massive data to reduce the service cost of the application program interface.

An embodiment of the present invention discloses a data pagination automation method, for processing a plurality of data items, comprises determining a sorting basis for sorting the plurality of data items according to an ordered unique key of the plurality of data items; sorting and paginating the plurality of data items according to the sorting basis; and updating a pagination information table of the plurality of data items and collecting corresponding data according to the ordered unique key and at least a filtering condition; wherein the step of sorting and paginating the plurality of data items according to the sorting basis comprises sorting the plurality of data items according to the ordered unique key, a pagination number and a quantity of data items of each pagination; reading data of each pagination according to the quantity of data items of each pagination and a cursor value; and storing data of each pagination and a last pagination according to the cursor value; wherein the pagination information table is updated with to a partial dynamic update method.

Another embodiment of the present invention discloses a computer system, for a server, comprises an application program interface, configured to provide a service interface; an arithmetic logic unit, configured to determine a sorting basis for sorting the plurality of data items according to an ordered unique key of the plurality of data items, and to sort and paginate the plurality of data items according to the sorting basis; and a backend module, configured to update a pagination information table of the plurality of data items and collect corresponding data according to the ordered unique key and at least a filtering condition; wherein the arithmetic logic unit is configured to determine a pagination number and a quantity of data items of each pagination, to sort the plurality of data items according to the ordered unique key, the pagination number and the quantity of data items of each pagination; to read data of each pagination according to the quantity of data items of each pagination and a cursor value; and to store data of each pagination and a last pagination according to the cursor value; wherein the pagination information table is updated with to a partial dynamic update method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of a data pagination automation method according to an embodiment of the present invention.

FIG. 3 is a schematic diagram of a pagination flowchart of data sheets according to an embodiment of the present invention.

FIG. 4 is a schematic diagram of a flowchart of obtaining data according to an embodiment of the present invention.

FIG. 5 is a schematic diagram of a flowchart of updating pagination information table according to an embodiment of the present invention.

FIG. 6 is a schematic diagram of a flowchart of updating pagination information table according to another embodiment of the present invention.

FIG. 7 is a schematic diagram of a splitting flowchart according to an embodiment of the present invention.

### DETAILED DESCRIPTION

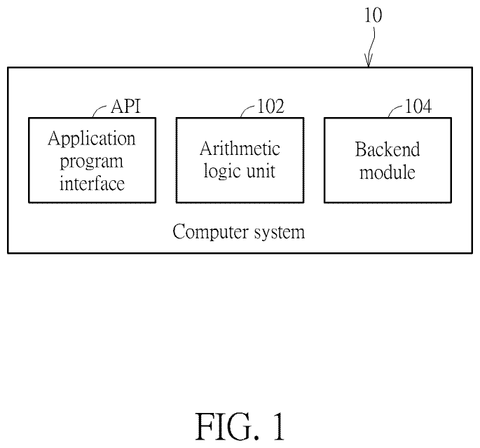

Please refer to FIG. 1, which is a schematic diagram of a computer system 10 according to an embodiment of the present invention. The computer system 10 includes an application program interface API, an arithmetic logic unit 102 and a backend module 104. The computer system 10 may be utilized for a server of a data center or a database to store massive data. The application program interface API is configured to provide a service interface. For example, the application program interface API may provide an inquiry interface, such that after users or those who need the data input at least a filtering condition or inquiry condition, the results conforming to the filtering condition or the inquiry condition may be presented. The arithmetic logic unit 102 is configured to determine a sorting basis for sorting according to an ordered unique key of the data stored in the server or the database, and to sort and paginate the data according to the sorting basis. The backend module 104 is configured to update a pagination information table of the data and to collect corresponding data according to the ordered unique key and the filtering condition.

Therefore, the computer system 10 according to an embodiment of the present invention may rapidly perform the pagination for massive data with consistent logic to automatically paginate the data sheets, such that the service cost of the application program interface API is reduced.

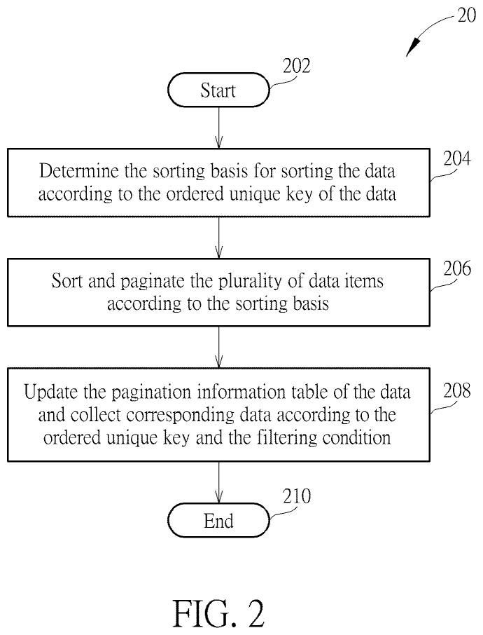

Please refer to FIG. 2, which is a schematic diagram of a data pagination automation method 20 according to an embodiment of the present invention. The data pagination automation method 20 may be utilized for processing the data of the computer system 10 and include the following steps:
Step 202: Start;
Step 204: Determine the sorting basis for sorting the data according to the ordered unique key of the data;
Step 206: Sort and paginate the plurality of data items according to the sorting basis;
Step 208: Update the pagination information table of the data and collect corresponding data according to the ordered unique key and the filtering condition;
Step 210: End.

In detail, the computer system 10 may include a data sheet with all pagination information, wherein the data sheet may include different columns, e.g. time, identification (ID), name, class. Results of pagination may be different based on different columns for sorting. In another embodiment, results of pagination may be different based on different sorting order with identical column combination.

The data pagination automation method 20 according to an embodiment of the present invention determines the sorting basis for sorting in step 204. Since the data of data sheet are non-repetitive, i.e. a combination of all columns is a unique key, e.g. a data sheet of identification column with serial numbers. Notably, the unique key of a data sheet may be more than one.

After determining the column of the unique key as the sorting basis, the unique key is an ordered unique key (OUK). In this situation, only one result is generated for sorting according to the data sheet and the ordered unique key.

In an embodiment, the ordered unique key includes a scoring measurement Score (OUK). An optimal ordered unique key is the ordered unique key with the highest scoring measurement.

The scoring measurement Score (OUK) determines characteristics of each column of the data sheet, e.g. time, string or numerical value. Then, a uniqueness ratio and an empty ratio of each column are calculated, wherein the uniqueness ratio=number of uniqueness/number of all data items; the empty ratio=number of empty items/number of all data items.

The scoring measurement

$$Score ( OUK ) = \frac{{Σ}_{i = 0}^{N} {e}^{- i} ( {i}^{t h} column score )}{{Σ}_{i = 0}^{N} {e}^{- i}} \qquad ( 1 )$$

wherein a column

$$score = \frac{2 \times w e i g hting of column characteristics}{uniqueness ratio + empty ratio} \qquad ( 2 )$$

In an embodiment, the weightings of column characteristic of time, string and numerical value are respectively 0.6, 0.3 and 0.1. In this example, the score measurement mainly sorts the time column. In another embodiment, the column score is higher when a repeatability of the column is higher and the empty value is less, i.e. the score measurement preferably selects and sorts the column with higher repeatability and less empty value. As can be known by formula (1), the scoring measurement Score (OUK) is the weighting and is exponentially decreased with the column score.

Therefore, in an embodiment, all candidate unique keys are listed, and then all candidate unique keys are expanded as candidate ordered unique keys. The scoring measurement Score (OUK) is utilized for scoring all candidate ordered unique keys to determine the optimal ordered unique key of the data sheet.

In addition to the above method for determining the candidate unique keys, the arithmetic logic unit 102 of the computer system 10 according to an embodiment of the present invention may directly assign the candidate unique key. For example, in order to prevent repeat values from contaminating the data sheet and to maintain the characteristic of the original data sheet, a primary key is established to determine the sorting method. Alternatively, the candidate unique key may be selected to cooperate with the column characteristic of columns of the data sheet, such that the optimal ordered unique key, which conforms to the characteristic of the data sheet, may be selected.

In an embodiment, the ordered unique key with the highest scoring measurement Score (OUK) may be more than one. In this situation, the arithmetic logic unit 102 of the computer system 10 according to an embodiment of the present invention may add a mechanism to select the only one optimal ordered unique key. For example, the optimal ordered unique key with the fewest column number, the optimal ordered unique key with the time column in the front of the data sheet, the optimal ordered unique key with the most time columns, the optimal ordered unique key with the most time columns or the optimal ordered unique key with the fewest value columns may be selected.

The unique sorting basis for the data sheet is determined according to the optimal ordered unique key determined in step 204. Then, the arithmetic logic unit 102 of the computer system 10 may sort and paginate the data according to the sorting basis and store related information of the pagination.

In detail, the computer system 10 may include the pagination information table and a calculation method of hashed value, and store the pagination information according to related parameters of the pagination, e.g. the pagination number and the data items of each pagination. The pagination information table may include columns of the table name, the ordered unique key, the pagination page, the initial data value, the quantity of data items, the data hashed value and the update time.

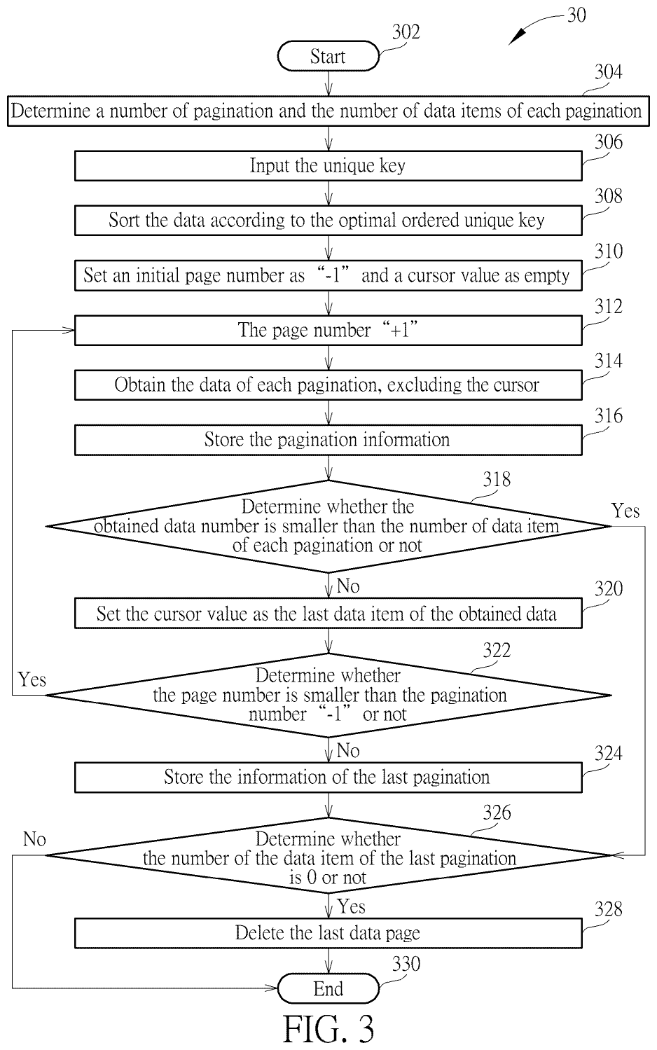

Please refer to FIG. 3, which is a schematic diagram of a pagination flowchart 30 of data sheets according to an embodiment of the present invention. The pagination flowchart 30 of data sheets includes the following steps:
Step 302: Start;
Step 304: Determine a number of pagination and the number of data items of each pagination;
Step 306: Input the unique key;
Step 308: Sort the data according to the optimal ordered unique key;
Step 310: Set an initial page number as “−1” and a cursor value as empty;
Step 312: The page number “+1”;
Step 314: Obtain the data of each pagination, excluding the cursor;
Step 316: Store the pagination information;
Step 318: Determine whether the obtained data number is smaller than the number of data item of each pagination or not, if yes, go to step 326, if not, go to step 320;
Step 320: Set the cursor value as the last data item of the obtained data;
Step 322: Determine whether the page number is smaller than the pagination number “−1” or not, if yes, go to step 312, if not go to step 324;
Step 324: Store the information of the last pagination;
Step 326: Determine whether the number of the data item of the last pagination is 0 or not, if yes, go to step 328, if not go to step 330;
Step 328: Delete the last data page;
Step 330: End.

Notably, the data hashed value is obtained after the data value of the last item of data is deleted and encrypted with the hashed value. In addition, the unique key of step 304 is not limited to the optimal ordered unique key; when the data hashed value of the last pagination is not empty, the pagination of the data sheets is finished. When the data hashed value of the last pagination is empty, more data of the data sheet are left to be paginated.

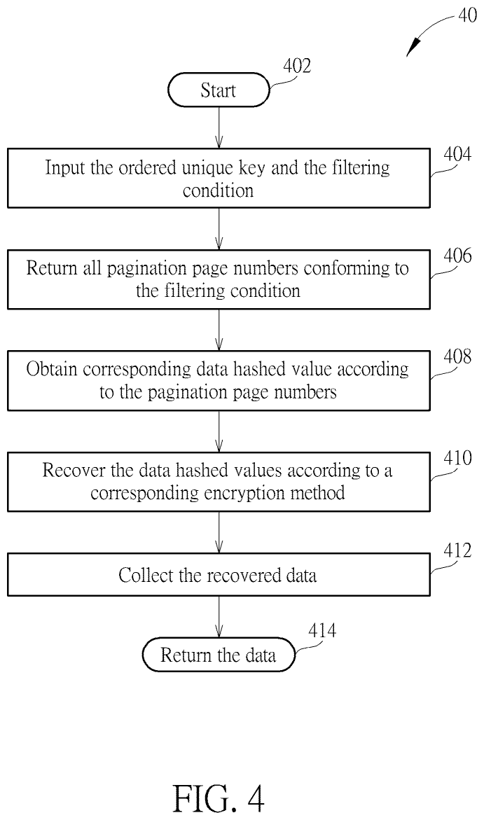

In an embodiment, the application program interface API according to an embodiment of the present invention provides the interface for the users to set the inquiry conditions to obtain the data. Please refer to FIG. 4, which is a schematic diagram of a flowchart 40 of obtaining data according to an embodiment of the present invention. The flowchart 40 of obtaining data includes the following steps:
Step 402: Start;
Step 404: Input the ordered unique key and the filtering condition;
Step 406: Return all pagination page numbers conforming to the filtering condition;
Step 408: Obtain corresponding data hashed value according to the pagination page numbers;
Step 410: Recover the data hashed values according to a corresponding encryption method;
Step 412: Collect the recovered data;
Step 414: Return the data.

Notably, the query commands of the application program interface API of the computer system 10, e.g. between, larger and smaller, are the executable query commands, and not limited thereto.

The data pagination automation method 20 updates the information of the pagination information table and collects corresponding data according to the ordered unique key and the filtering condition in step 206.

In order to ensure that the user may obtain correct information of pagination, the pagination information table of the computer system 10 is updated under different situations.
1. When the data needed by the user is at the last pagination, and the data hashed value of the last pagination is empty;
2. The data of the data sheet is moved because of scheduling; and
3. When too much pagination data, the pagination is split.

In order to avoid the increase of the pagination cost, the computer system 10 according to an embodiment of the present invention partially paginates the pagination information table to determine whether the data needed by the user is at the pagination with empty hashed value or not. If yes, no splitting is performed; if not, data splitting is performed until the requirement of the user is satisfied to avoid unnecessary splitting cost.

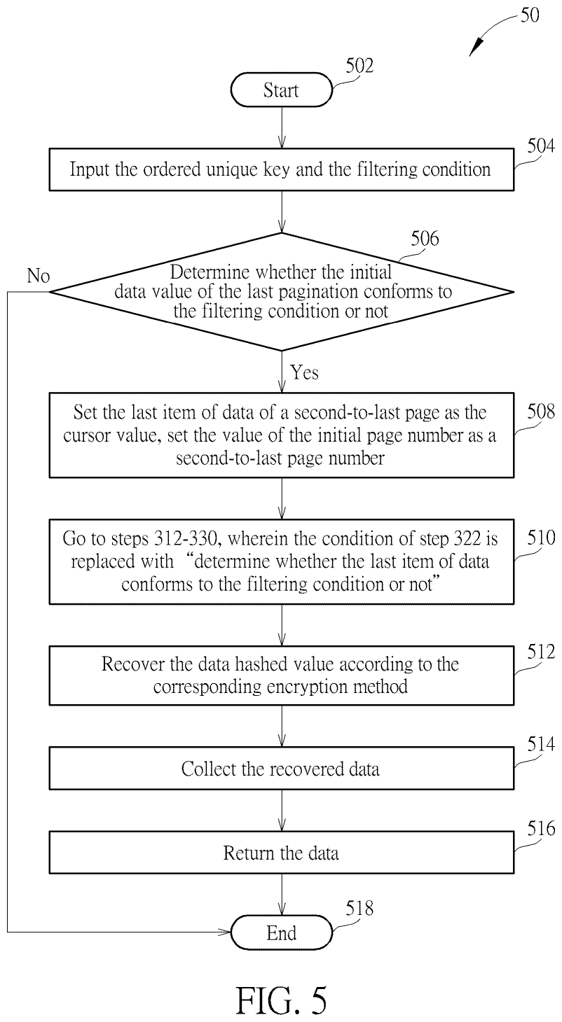

Please refer to FIG. 5, which is a schematic diagram of a flowchart 50 of updating pagination information table according to an embodiment of the present invention. The flowchart 50 of updating pagination information table includes the following steps:
Step 502: Start;
Step 504: Input the ordered unique key and the filtering condition;
Step 506: Determine whether the initial data value of the last pagination conforms to the filtering condition or not, if yes, go to step 508, if not, go to step 518;
Step 508: Set the last item of data of a second-to-last page as the cursor value, set the value of the initial page number as a second-to-last page number;
Step 510: Go to steps 312-330, wherein the condition of step 322 is replaced with “determine whether the last item of data conforms to the filtering condition or not”;
Step 512: Recover the data hashed value according to the corresponding encryption method;
Step 514: Collect the recovered data;
Step 516: Return the data;
Step 518: End.

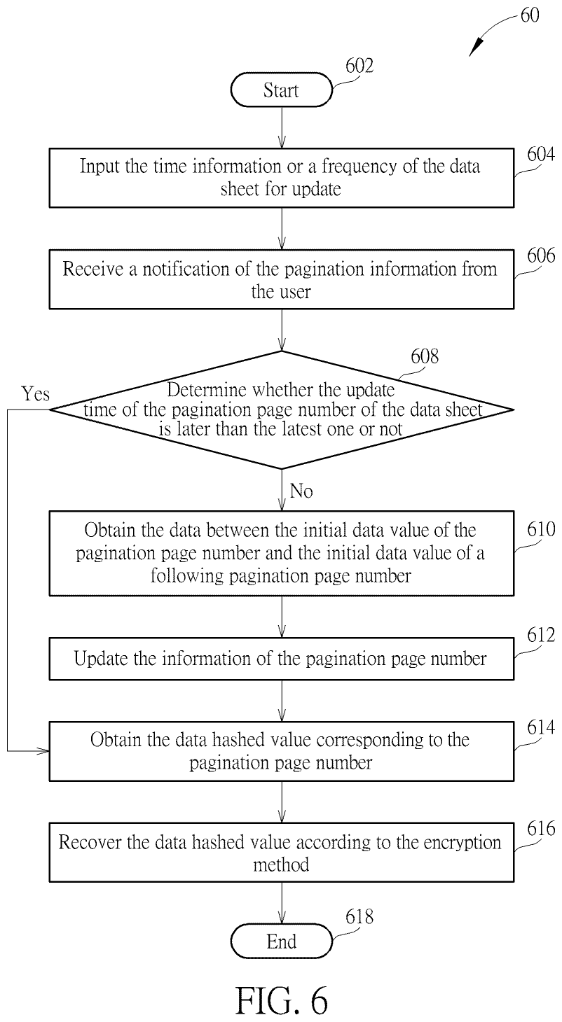

On the other hand, the computer system 10 according to an embodiment of the present invention may update the data sheet with a fixed periodic scheduling method, e.g. the data sheet is updated every 19:00. Please refer to FIG. 6, which is a schematic diagram of a flowchart 60 of updating pagination information table according to an embodiment of the present invention. The flowchart 60 of updating pagination information table includes the following steps:
Step 602: Start;
Step 604: Input the time information or a frequency of the data sheet for update;
Step 606: Receive a notification of the pagination information from the user;
Step 608: Determine whether the update time of the pagination page number of the data sheet is later than the latest one or not, if yes, go to step 614, if not, go to step 610;
Step 610: Obtain the data between the initial data value of the pagination page number and the initial data value of a following pagination page number;
Step 612: Update the information of the pagination page number;
Step 614: Obtain the data hashed value corresponding to the pagination page number;
Step 616: Recover the data hashed value according to the encryption method;
Step 618: End.

Therefore, the computer system 10 according to an embodiment of the present invention may partially and dynamically update the pagination information table. After receiving the notification from the user, the latest state of the pagination may be confirmed, if yes, the current pagination information is directly transmitted to the user; if not, the pagination information is updated and transmitted to the user.

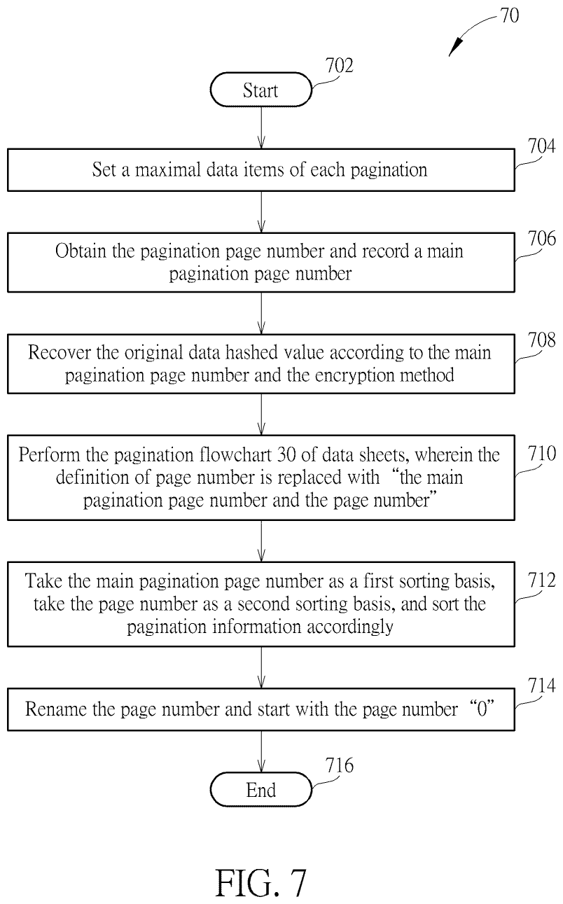

Since the download speed of pagination might be affected after the data sheets are updated with excessive data and additional pagination. In order to avoid such situation, the computer system 10 according to an embodiment of the present invention may manage the data items of each pagination and perform the splitting for the data sheet. Please refer to FIG. 7, which is a schematic diagram of a splitting flowchart 70 according to an embodiment of the present invention. The splitting flowchart 70 includes the following steps:
Step 702: Start;
Step 704: Set a maximal data items of each pagination;
Step 706: Obtain the pagination page number and record a main pagination page number;
Step 708: Recover the original data hashed value according to the main pagination page number and the encryption method;
Step 710: Perform the pagination flowchart 30 of data sheets, wherein the definition of page number is replaced with “the main pagination page number and the page number”;
Step 712: Take the main pagination page number as a first sorting basis, take the page number as a second sorting basis, and sort the pagination information accordingly;
Step 714: Rename the page number and start with the page number
Step 716: End.

The computer system 10 according to an embodiment of the present invention may dynamically update the pagination when performing the splitting flowchart 70, wherein the variation is performed when the user requests a demand of obtaining the data of a pagination, and the computer system 10 determines whether the maximal data number of the pagination is met or not, if yes, the backend module 104 splits the pagination information table, and replaces the pagination information table with the split pagination information table.

In addition, the original pagination information table may be utilized for providing the data during the split period and the service quality for the user would not be affected.

Notably, those skilled in the art may make proper modifications to the data pagination automation method according to different requirements, not limited thereto and can be modified according to different user's preferences or system settings, which are all within the scope of the present invention.

In summary, the present invention provides a data pagination automation method and a related computer system, which is capable of rapidly paginating massive data with consistent logic and achieves the data pagination automation, so as to reduce service cost of the application program interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data pagination automation method, for processing a plurality of data items, comprising:
determining a sorting basis for sorting the plurality of data items according to an ordered unique key of the plurality of data items;
sorting and paginating the plurality of data items according to the sorting basis; and
updating a pagination information table of the plurality of data items and collecting corresponding data according to the ordered unique key and at least a filtering condition;
wherein the step of sorting and paginating the plurality of data items according to the sorting basis comprises:
sorting the plurality of data items according to the ordered unique key, a pagination number and a quantity of data items of each pagination;
reading data of each pagination according to the quantity of data items of each pagination and a cursor value; and
storing data of each pagination and a last pagination according to the cursor value;
wherein the pagination information table is updated with to a partial dynamic update method.

2. The data pagination automation method of claim 1, wherein the step of determining the sorting basis for sorting the plurality of data items according to the ordered unique key of the plurality of data items comprises:
listing at least a candidate unique key of the plurality of data items;
expanding the at least a candidate unique key as at least an ordered unique key; and
determining an optimal ordered unique key according to a characteristic of each column of the plurality of data items and the at least an ordered unique key.

3. The data pagination automation method of claim 2, wherein the step of determining the optimal ordered unique key according to the characteristic of the each column of the plurality of data items and the at least an ordered unique key comprises:
calculating a uniqueness ratio or an empty ratio of each column of the plurality of data items to determine a column score corresponding to the each column of the plurality of data items; and
determining the optimal ordered unique key according to the column score, a column characteristic weighting and the empty ratio corresponding to the each column of the plurality of data items.

4. The data pagination automation method of claim 1, wherein a last data page is deleted when a quantity of data item of the information of the last pagination is zero.

5. The data pagination automation method of claim 1, further comprising:
transmitting a pagination page number of data conforming to the at least a filtering condition;
obtaining a hashed data value corresponding to the pagination page number; and
obtaining corresponding data according to the hashed data value and a corresponding encryption method.

6. The data pagination automation method of claim 1, wherein the step of updating the pagination information table of the plurality of data items and collecting corresponding data according to the ordered unique key and the at least a filtering condition comprises:
setting a last data item of a second-to-last page as a cursor value and setting an initial page number as a second-to-last page number, when an initial data value of data conforming to the at least a filtering condition is at a last pagination page.

7. The data pagination automation method of claim 1, wherein the pagination information table is updated when data conforming to the at least a filtering condition is at a last pagination page and a data hashed value corresponding to the last page is empty.

8. The data pagination automation method of claim 1, further comprising:
setting a maximal data quantity of each pagination of the pagination information table;
obtaining a pagination page number and a data hashed value corresponding to the pagination page number and recording the pagination page number as a main pagination page number; and
taking the main pagination page number and the pagination page number as a second sorting basis and re-paginating each pagination of the pagination information table.

9. A computer system, for a server, comprising:
an application program interface, configured to provide a service interface;
an arithmetic logic unit, configured to determine a sorting basis for sorting the plurality of data items according to an ordered unique key of the plurality of data items, and to sort and paginate the plurality of data items according to the sorting basis; and
a backend module, configured to update a pagination information table of the plurality of data items and collect corresponding data according to the ordered unique key and at least a filtering condition;
wherein the arithmetic logic unit is configured to determine a pagination number and a quantity of data items of each pagination, to sort the plurality of data items according to the ordered unique key, the pagination number and the quantity of data items of each pagination; to read data of each pagination according to the quantity of data items of each pagination and a cursor value; and to store data of each pagination and a last pagination according to the cursor value;
wherein the pagination information table is updated with to a partial dynamic update method.

10. The computer system of claim 9, wherein the arithmetic logic unit is configured to list at least a candidate unique key of the plurality of data items, expand the at least a candidate unique key as at least an ordered unique key, and determine an optimal ordered unique key according to a characteristic of each column of the plurality of data items and the at least an ordered unique key.

11. The computer system of claim 10, wherein the arithmetic logic unit is configured to calculate a uniqueness ratio or an empty ratio of each column of the plurality of data items to determine a column score corresponding to the each column of the plurality of data items, and to determine the optimal ordered unique key according to the column score, a column characteristic weighting and the empty ratio corresponding to the each column of the plurality of data items.

12. The computer system of claim 9, wherein a last data page is deleted when a quantity of data item of the information of the last pagination is zero.

13. The computer system of claim 9, wherein the arithmetic logic unit is configured to transmit a pagination page number of data conforming to the at least a filtering condition, obtain a hashed data value corresponding to the pagination page number, and obtain corresponding data according to the hashed data value and a corresponding encryption method.

14. The computer system of claim 9, wherein the backend module is configured to set a last data item of a second-to-last page as a cursor value and set an initial page number as a second-to-last page number, when an initial data value of data conforming to the at least a filtering condition is at a last pagination page.

15. The computer system of claim 9, wherein the pagination information table is updated when data conforming to the at least a filtering condition is at a last pagination page and a data hashed value corresponding to the last page is empty.

16. The computer system of claim 9, wherein the backend module is configured to set a maximal data quantity of each pagination of the pagination information table, to obtain a pagination page number and a data hashed value corresponding to the pagination page number and to record the pagination page number as a main pagination page number, and to take the main pagination page number and the pagination page number as a second sorting basis and to re-paginate each pagination of the pagination information table.
